(19) United States
(12) Patent Application Publication
(10) Pub. No.: US 2023/0287873 A1
(43) Pub. Date: Sep. 14, 2023

(54) FUEL PUMP ASSEMBLY

(71) Applicant: Cummins Inc., Columbus, IN (US)

(72) Inventors: Donald J. Benson, Columbus, IN (US); Eric A. Benham, Columbus, IN (US); Ahmad M. Sabri, Columbus, IN (US); Samuel David Griffith Magnuson, Louisville, KY (US)

(21) Appl. No.: 18/318,830

(22) Filed: May 17, 2023

Related U.S. Application Data
(63) Continuation of application No. PCT/US2020/060934, filed on Nov. 18, 2020.

(51) Int. Cl. F04B 9/04; F04B 1/0417; F02M 59/10

(52) U.S. Cl. CPC F04B 9/042; F02M 59/102; F04B 1/0417

(57) ABSTRACT

A pumping assembly includes at least one removable unit barrel pumping assembly coupled to a housing of the pumping assembly. The pumping assembly further includes a drive member having a roller configured to engage a portion of the unit barrel pumping assembly during operation of the pumping assembly. The roller is configured to include a plurality of geometric shapes to distribute load forces during operation of the pumping assembly.

### FIELD OF THE INVENTION

The present disclosure relates to a fuel pump assembly, and more particularly, to a fuel pump assembly having at least one removable unit barrel coupled to a housing of the fuel pump to control fuel flow into the housing.

### BACKGROUND OF THE DISCLOSURE

Fuel pumps are provided on combustion engines to deliver high-pressure fuel to the injectors which enables high-pressure injection events when the engine is operating. Depending on the operating parameters of the engine, fuel pumps may be configured to handle high and/or low fuel pressures. Where high pressure fuel is required, high-pressure, fuel-lubricated pumps may be used. However, even though such fuel pumps are designed for high-pressure fuels, a need exists for a high-pressure fuel pump which is configured to improve the fatigue capability of the plunger of the fuel pump, reduce forces on various components of the fuel pump, thereby reducing wear and power losses, and distribute loading between various components of the fuel pump.

### SUMMARY OF THE DISCLOSURE

As disclosed herein, the present application relates to fuel-lubricated fuel pump configured for various fuel pressures, including high fuel pressures. The configuration of the fuel pump disclosed herein provides a plunger interface design which acts to improve the fatigue capability of the plunger at the plunger foot transition, reduce side loading forces at the plunger to decrease wear and scuffing power losses, reduce the sliding motion of the plunger foot at the interface with the cam ring or roller, provide internal forces which limit the z-axis motion of the cam roller to minimize the need for additional z-axis thrust-load-carrying features, and/or distribute the loading between various components in the direction perpendicular to the rotation of the cam.

In one embodiment, a pumping assembly comprises a housing, a drive member configured to extend within the housing, and at least one unit barrel pumping assembly removably coupled to the housing and including a pumping member configured to move in response to movement of the drive member.

In a further embodiment, a pumping assembly comprises a housing, a drive member configured to extend through a portion of the housing, a roller supported by a portion of the drive member, and at least one unit barrel pumping assembly supported by the housing and including a plunger having a plunger foot. The plunger foot is configured to engage a portion of the roller. The roller is configured with one of a convex or concave geometric configuration and the plunger foot is configured with one of a convex or concave geometric configuration.

In another embodiment, a pumping assembly comprises a housing, a drive member configured to extend through a portion of the housing, a roller supported by a portion of the drive member, a first unit barrel pumping assembly supported by the housing, and a second unit barrel pumping assembly supported by the housing. The first unit barrel pumping assembly includes a first plunger configured to reciprocate along a first reciprocation axis, and the plunger comprises a plunger foot having a curved contact surface. The second unit barrel pumping assembly includes a second plunger configured to reciprocate along a second reciprocation axis, and the second reciprocation axis is offset from the first reciprocation axis.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a schematic view of an internal combustion engine configured for use with a fuel pump assembly of the present disclosure;

FIG. 2 is a schematic view of a fuel pump assembly coupled to a portion of the engine of FIG. 1;

FIG. 3 is perspective view of the fuel pump assembly of FIG. 2;

FIG. 4 is a further perspective view of the fuel pump assembly of FIG. 2;

FIG. 5 is an exploded view of the fuel pump assembly of FIG. 3;

FIG. 6 is an exploded view of the fuel pump assembly of FIG. 4;

FIG. 7A is a cross-sectional view of the fuel pump assembly of FIG. 3, taken along line 7A-7A of FIG. 3, with a cam in a first position;

FIG. 7B is a cross-sectional view of the fuel pump assembly of FIG. 5A with the cam in a second position;

FIG. 8 is a detailed, cross-sectional of an inlet metering valve assembly of the fuel pump assembly of FIG. 5A;

FIG. 9 is a cross-sectional view of the fuel pump assembly of FIG. 3, taken along line 9-9 of FIG. 3;

FIG. 10A is a first embodiment of a plunger foot and a cam roller of the fuel pump assembly of FIG. 2, showing a concave plunger foot and a convex cam roller;

FIG. 10B is a second embodiment of a plunger foot and a cam roller of the fuel pump assembly of FIG. 2, showing a convex plunger foot and a concave cam roller;

FIG. 10C is a prior art embodiment of a flat plunger foot engaged with a flat surface of a cam roller;

FIG. 11 is a perspective view of an alternative embodiment fuel pump assembly having a single unit barrel pumping assembly; and

FIG. 12 is a cross-sectional view of the fuel pump assembly of FIG. 11, taken along line 12-12 of FIG. 11.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings.

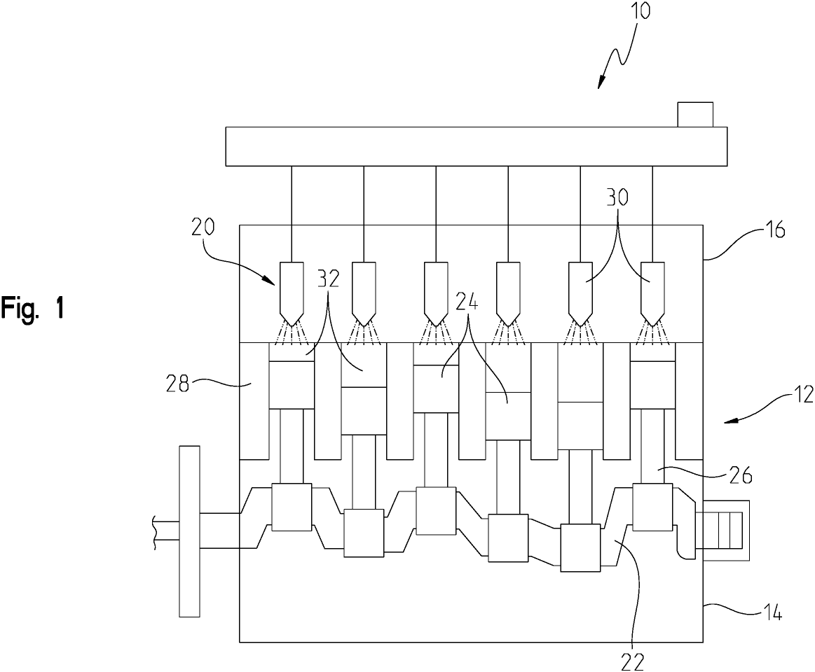

Referring to FIG. 1, a portion of an internal combustion engine 10 is shown as a simplified schematic. Engine 10 includes an engine body 12, which supports an engine block 14, a cylinder head 16 coupled to engine block 14, and a fuel system 20. Engine body 12 further includes a crankshaft 22, a plurality of pistons 24, and a plurality of connecting rods 26. Pistons 24 are configured for reciprocal movement within a plurality of engine cylinders 28, with one piston 24 positioned in each engine cylinder 28. Each piston 24 is operably coupled to crankshaft 22 through one of connecting rods 26. A plurality of combustion chambers 32 are each defined by one piston 24, cylinder head 16, and cylinder 28. The movement of pistons 24 under the action of a combustion process in engine 10 causes connecting rods 26 to move crankshaft 22.

When engine 10 is operating, a combustion process occurs in combustion chambers 32 to cause movement of pistons 24. The movement of pistons 24 causes movement of connecting rods 26, which are drivingly connected to crankshaft 22, and movement of connecting rods 26 causes rotary movement of crankshaft 22. The angle of rotation of crankshaft 22 may be measured by the control system to aid in timing the combustion events in engine 10 and for other purposes. The angle of rotation of crankshaft 22 may be measured in a plurality of locations, including a main crank pulley (not shown), an engine flywheel (not shown), an engine camshaft (not shown), or on crankshaft 22.

Fuel system 20 includes a plurality of fuel injectors 30 positioned within cylinder head 16. Each fuel injector 30 is fluidly coupled to one combustion chamber 32. In operation, fuel system 20 provides fuel to fuel injectors 30, which is then injected into combustion chambers 32 by the action of fuel injectors 30, thereby forming one or more injection events or cycles. As detailed further herein, the injection cycle may be defined as the interval that begins with the movement of a nozzle or needle element to permit fuel to flow from fuel injector 30 into an associated combustion chamber 32, and ends when the nozzle or needle element moves to a position to block the flow of fuel from fuel injector 30 into combustion chamber 32.

Crankshaft 22 drives at least one fuel pump to pull fuel from the fuel tank in order to move fuel toward fuel injectors 30. A control system (not shown) provides control signals to fuel injectors 30 that determine operating parameters for each fuel injector 30, such as the length of time fuel injectors 30 operate and the number of fueling pulses per a firing or injection cycle period, thereby determining the amount of fuel delivered by each fuel injector 30.

In addition to fuel system 20, the control system controls, regulates, and/or operates other components of engine 10 that may be controlled, regulated, and/or operated through a control system (not shown). More particularly, the control system may receive signals from sensors located on engine 10 and transmit control signals or other inputs to devices located on engine 10 in order to control the function of such devices. The control system may include a controller or control module (not shown) and a wire harness (not shown). Actions of the control system may be performed by elements of a computer system or other hardware capable of executing programmed instructions, for example, a general purpose computer, special purpose computer, a workstation, or other programmable data processing apparatus. These various control actions also may be performed by specialized circuits (e.g., discrete logic gates interconnected to perform a specialized function), by program instructions (software), such as logical blocks, program modules, or other similar applications which may be executed by one or more processors (e.g., one or more microprocessors, a central processing unit (CPU), and/or an application specific integrated circuit), or any combination thereof. For example, embodiments may be implemented in hardware, software, firmware, middleware, microcode, or any combination thereof. Instructions may be in the form of program code or code segments that perform necessary tasks and can be stored in a non-transitory, machine-readable medium such as a storage medium or other storage(s). A code segment may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. In this way, the control system is configured to control operation of engine 10, including fuel system 20.

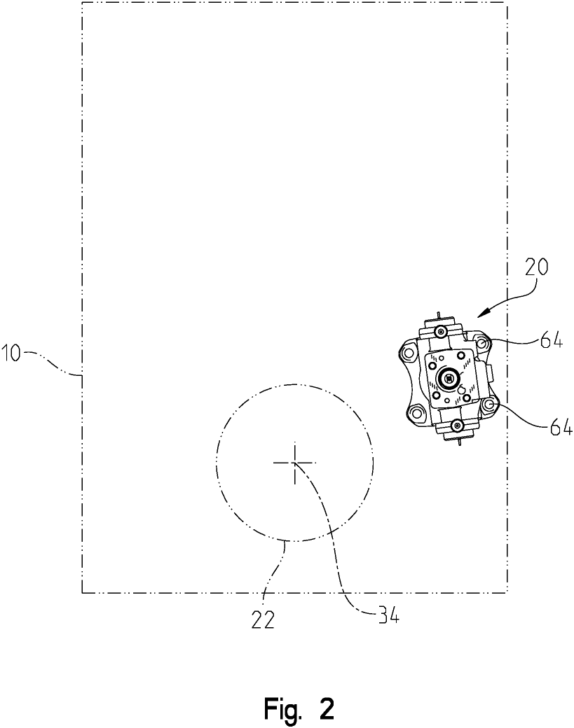

Referring to FIG. 2, engine 10 is shown with crankshaft 22 configured to rotate about a crankshaft axis 34. A portion of fuel system 20, illustratively a fuel pump 40, is supported on engine 10 at any location and, in one embodiment, may be positioned generally proximate crankshaft 22. In such embodiments, the rotation of crankshaft 22 about axis 34 may cause movement of a portion of fuel pump 40 such that fuel flows into and out of fuel pump 40 in response to rotation of crankshaft 22.

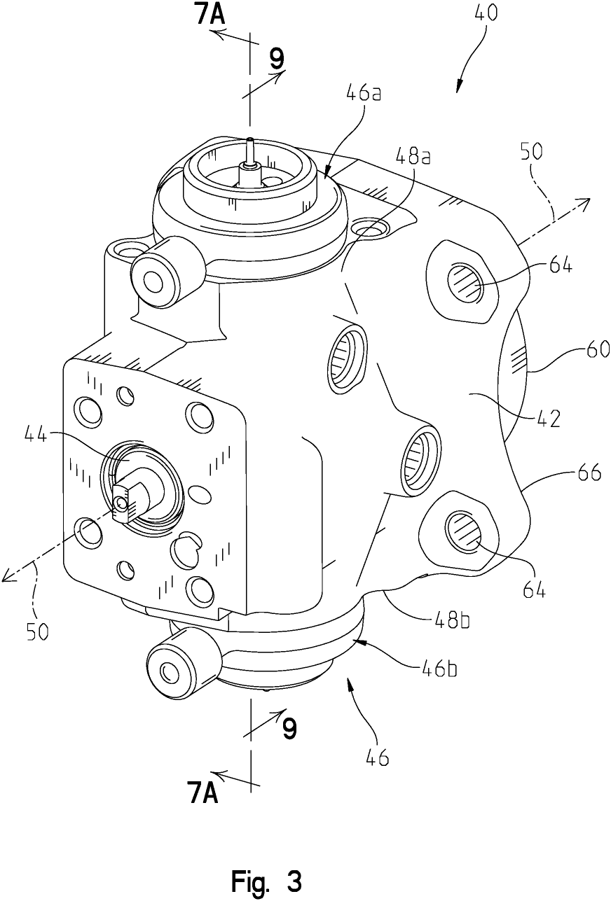

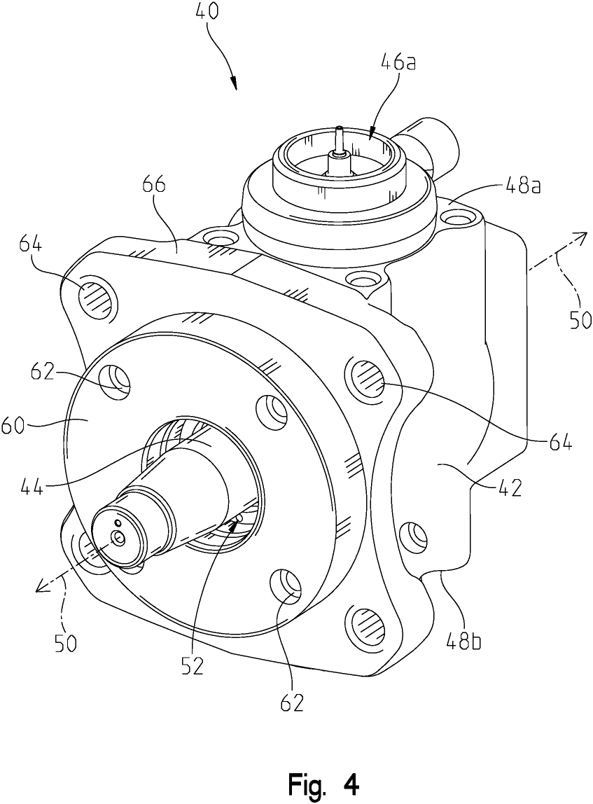

Referring to FIG. 3-7B, fuel pump 40 may be a high-pressure, fuel-lubricated pump. Pump 40 includes a housing 42 configured to support a plurality of components, such as a drive member, illustratively a camshaft 44, configured to rotate about an axis of rotation 50 and at least one unit barrel pumping assembly 46. Illustratively, unit barrel pumping assembly 46 includes a first unit barrel pumping assembly 46a positioned on a first side 48a of housing 42 and a second unit barrel pumping assembly 46b positioned on a second, opposing side 48b of housing 42. As shown, camshaft 44 is supported within a central cavity 52 of housing 42 and first and second unit barrel pumping assemblies 46 are positioned on opposing sides of central cavity 52 in a direction perpendicular to camshaft axis of rotation 50.

Unit barrel pumping assembly 46 is removably coupled to housing 42 and is not integrally formed therewith. In this way, if a component of unit barrel pumping assembly 46 needs to be replaced or repaired, the entirety of housing 42 is not affected, as just unit barrel pumping assembly 46 may be replaced or repaired. Further, because unit barrel pumping assembly 46 is removable from housing 42, unit barrel pumping assembly 46 may be comprised of a different material from housing 42, thereby allowing for weight reduction or other benefits of dissimilar materials for fuel pump 40. For example, as is disclosed further herein, only unit barrel pumping assembly 46 is configured to receive high-pressure fluid (e.g., fuel) and, therefore, housing 42 may be comprised of a lower strength material (e.g., aluminum) than unit barrel pumping assembly 46. Additionally, unit barrel pumping assembly 46 may be specifically configured for high-pressure fluid/fuel flowing into fuel pump 40 and, because unit barrel pumping assembly 46 is not integrally formed with housing 42, unit barrel pumping assembly 46 may be customized for such pressures and/or other operating parameters. This modular configuration allows for flexibility during manufacture and assembly of fuel pump 40 and customization of fuel pump 40 to accommodate such operating parameters.

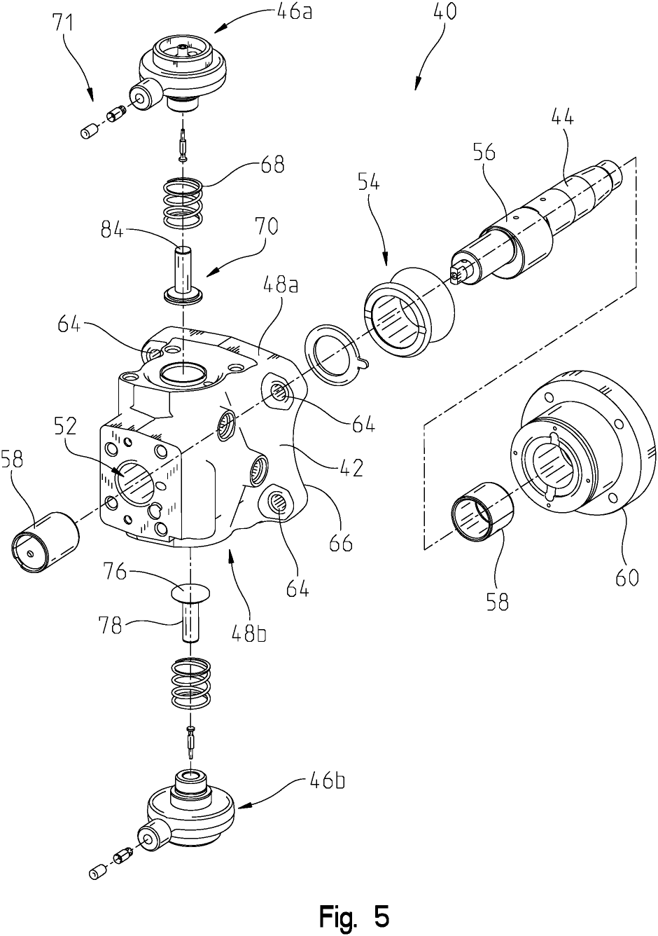

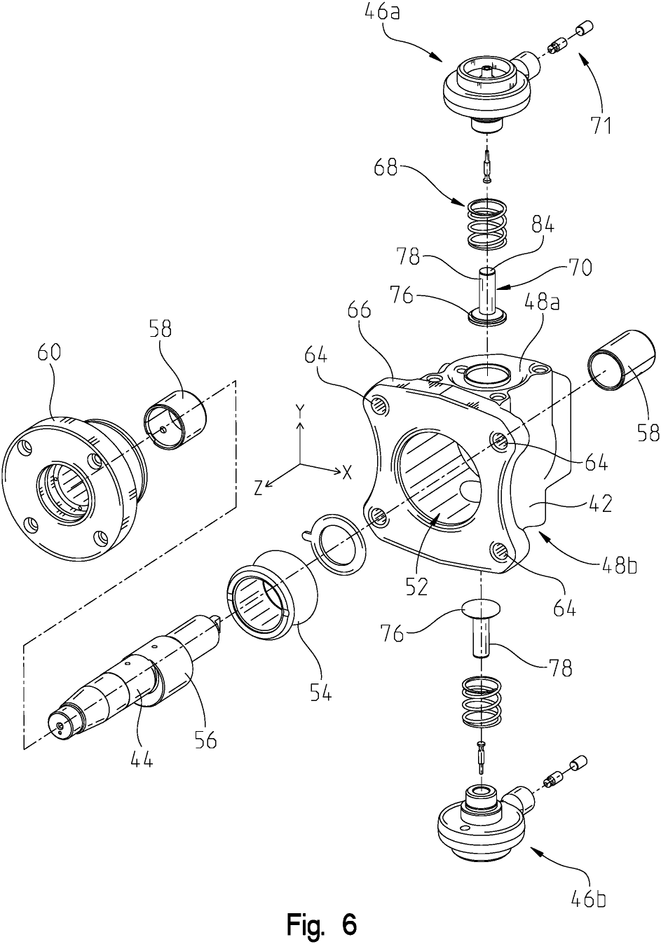

As shown best in FIGS. 5 and 6, housing 42 further supports a cam ring or roller 54 configured to engage a cam 56 of camshaft 44. Bearings 58 may be positioned along a portion of camshaft 44 and, illustratively, bearings 58 are positioned along opposing sides of cam 56. Camshaft 44 is configured to extend through housing 42 and extends through a support member 60. Bearing 58 is received within support member 60 such that bearing 58 is radially intermediate camshaft 44 and support member 60. Support member 60 is removably coupled to housing 42 with couplers (not shown) extending through openings 62.

Housing 42 of pump 40 also includes apertures 64 configured to receive couplers (not shown) for removably coupling pump 40 to a portion of the housing for engine 10. Illustratively, housing 42 includes four apertures 64. Apertures 64 extend through a plate 66 of housing 42. Plate 66 may be integrally formed with the remainder of housing 42 or may be separate from the remainder of housing 42. The location of apertures 64 allows pump 40 to be coupled to the housing of engine 10 in any configuration. More particularly, because the illustrative embodiment of pump 40 includes four apertures 64, and each aperture 64 is positioned at a corner of plate 66, pump 40 can be rotated in any direction against the housing of engine 10 to align apertures 64 with apertures on the housing of engine 10, thereby allowing compact and efficient packaging of pump 40 with other components of engine 10, components of a vehicle, etc.

Referring to FIGS. 5-9, unit barrel pumping assembly 46 is disclosed. Each unit barrel pumping assembly 46 includes a tension member 68 (e.g., a spring) and a plunger 70 fluidly coupled to an active inlet metering (“AIM”) valve assembly 72 which is configured to regulate the flow of high-pressure and/or low-pressure fluid into a pumping chamber 74. Pumping chamber 74 is defined by a portion of plunger 70 and a portion of unit barrel pumping assembly 46, as disclosed further herein. Plunger 70 also is fluidly coupled to a plunger outlet valve 71 of unit barrel pumping assembly 46.

Plunger 70 includes a plunger foot 76 and a plunger stem 78. Illustratively, plunger foot 76 has an outer diameter which is greater than the outer diameter of plunger stem 78. Plunger stem 78 extends through tension member 68 and reciprocates along walls 80 of unit barrel pumping assembly 46. More particularly, plunger stem 78 slides along and may be in contact with walls 80 during axial reciprocation of plunger stem 78 along axis 82. A distal end 84 of plunger stem 78 cooperates with walls 80 to define pumping chamber 74 which is configured to receive high- and/or low-pressure fluid from AIM valve assembly 72 during operation of pump 40. A proximate end 86 of plunger stem 78 is adjacent plunger foot 76. In one embodiment, plunger foot 76 is integrally formed with proximate end 86 of plunger stem such that plunger 70 is a unitary component, however, in other embodiments, plunger foot 76 may be separate from but coupled to proximate end 86 of plunger stem 78.

Referring still to FIGS. 5-9, plunger foot 76 is configured to contact and ride along cam roller 54 during operation of pump 40. More particularly, during operation of pump 40, camshaft 44 rotates which, therefore, rotates cam 56. Camshaft 44 is an eccentric camshaft in that the center of rotation of cam 56 is offset axis of rotation 50 of camshaft 44. Cam roller 54 surrounds cam 56 and is configured to rotate about cam 56. A hydraulic film or fluid is positioned at the interface between the inner diameter of cam roller 54 and the outer diameter of cam 56 to facilitate the movement of cam roller 54 relative to cam 56. Plunger 70 is biased towards cam roller 54 because of tension member 68 such that plunger foot 76 maintains contact with cam roller 54 during rotation thereof. The contact of plunger foot 76 with cam roller 54 results in reciprocation of plunger 70 along walls 80 because the rotation of cam 56 moves plunger 70 along reciprocation axis 82.

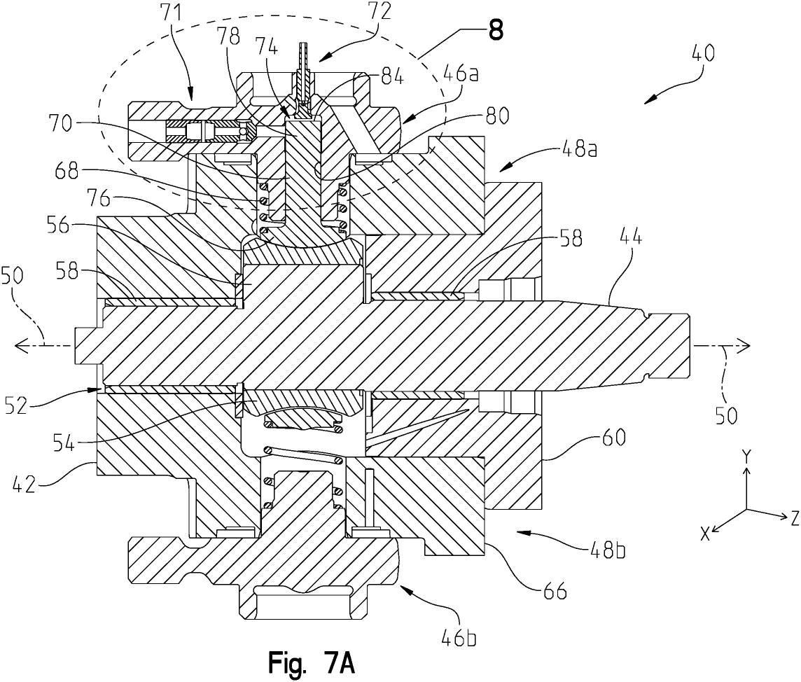

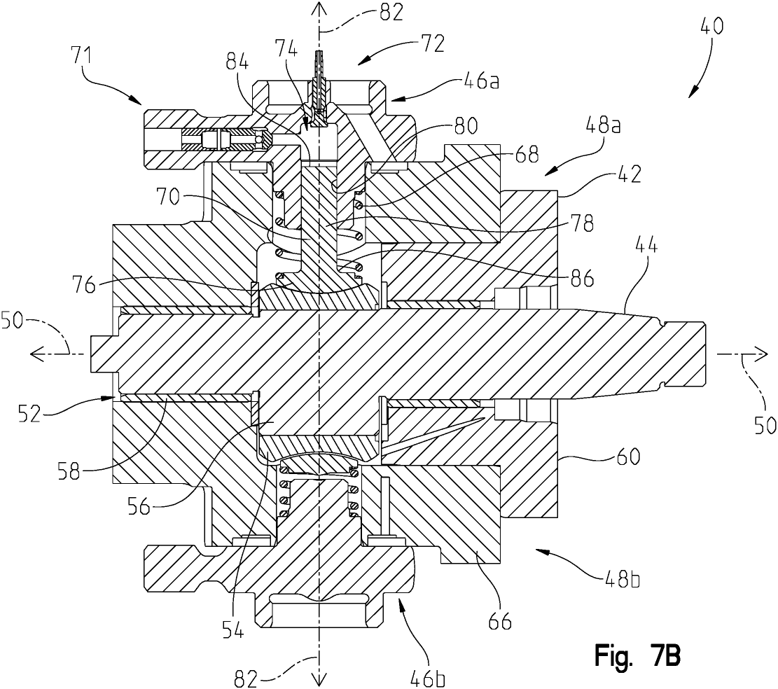

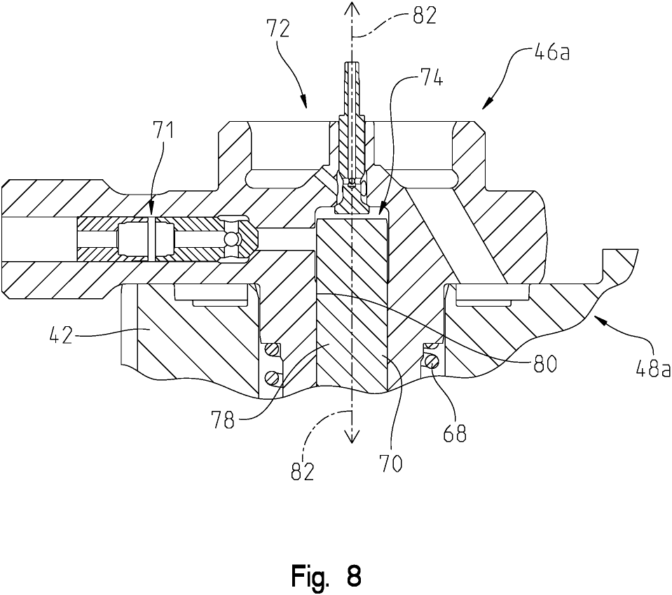

As plunger 70 reciprocates along axis 82 and, therefore, distal end 84 of plunger 70 moves along walls 80, distal end 84 moves towards and away from axis of rotation 50 of camshaft 44, thereby adjusting the volume of pumping chamber 74. More particularly, as shown best in FIGS. 7A and 8, when cam 56 rotates to a position towards first unit barrel pumping assembly 46a, plunger 70 also moves towards first unit barrel pumping assembly 46a and is in a top-dead-center position, thereby minimizing the volume of pumping chamber 74 between distal end 84 and an upper surface of walls 80.

However, as camshaft 44 continues to rotate about axis of rotation 50 and cam 56 rotates towards second unit barrel pumping assembly 46b, plunger 70 reciprocates along axis 82 and moves towards axis of rotation 50, as shown best in FIG. 7B. Because of tension member 68, plunger 70 is biased towards cam roller 54 and distal end 84 of plunger 70 moves towards axis of rotation 50, thereby increasing the volume of pumping chamber 74. When the volume of pumping chamber 74 is maximized, plunger 70 is at a bottom-dead-center position and a maximum amount of fluid from the corresponding unit barrel pumping assembly 46 flows therein.

As cam 56 further rotates and plunger 70 again reciprocates towards the corresponding unit barrel pumping assembly 46 and towards the position of FIGS. 7A and 8, the volume of the pumping chamber 74 is reduced and the movement of distal end 84 towards unit barrel pumping assembly 46 pushes the fluid out of pumping chamber 74. It may be appreciated that the movement of plunger 70 between the top-dead-center position of FIG. 7A and the bottom-dead-center position of FIG. 7B defines a full stroke of plunger 70.

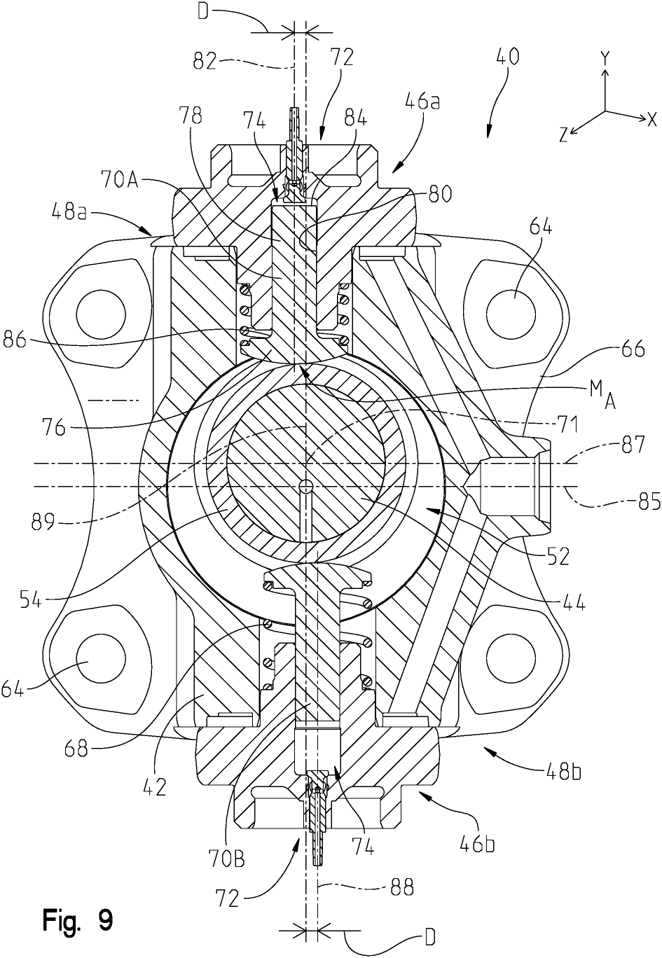

Referring to FIG. 9, the embodiment of pump 40 includes two unit barrel pumping assemblies 46a, 46b, however, the reciprocation axes of unit barrel pumping assemblies 46a, 46b are offset from each other. Illustratively, first unit barrel pumping assembly 46a includes plunger 70A configured to reciprocate along axis 82 and second unit barrel pumping assembly 46b includes plunger 70B configured to reciprocate along axis 88. When plunger 70A is in a top-dead-center position, reciprocation axis 82 is offset to a first side of axis of rotation 50 of camshaft 44 while reciprocation axis 88 of second unit barrel pumping assembly 46b is offset to a second side of axis of rotation 50 of camshaft 44. Additionally, as shown best in FIG. 9, axis of rotation 50 of camshaft 44 is perpendicular to a line 85 defining the exact center of pump 40 (i.e., line 85 equally divides pump 40 in half) and, when cam 56 is rotated towards first unit barrel pumping assembly 46a, line 85 is positioned below a line 87 which defines the center of cam 56 and is perpendicular to an axis of rotation 91 of cam 56. Lines 85 and 87 are perpendicularly intersected by a vertical or Y-axis 89 which is positioned laterally between axes 82 and 88, as shown in FIG. 9, and Y-axis 89 is perpendicular to axis of rotation 50. By positioning the reciprocation axes 82, 88 of respective first and second unit barrel pumping assemblies 46a, 46b on opposing sides of axis of rotation 50 of camshaft 44, each plunger 70 reciprocates in its own, unique plane which minimizes loading torque on camshaft 44.

More particularly, prior art fuel pumps which include an eccentric cam, a cam ring, and a plunger pumping arrangement are typically limited by high contact stresses between the plunger and the cam ring, as well as fatigue related to high stresses at the transition from the plunger pumping diameter to the plunger foot. For example, and as disclosed further herein, with such prior art pumps, high side loading forces between the plunger and various surfaces of the pumping arrangement may reduce efficiency and durability of the pump, thereby resulting in high scuffing power at the plunger and the surfaces of the pumping arrangement.

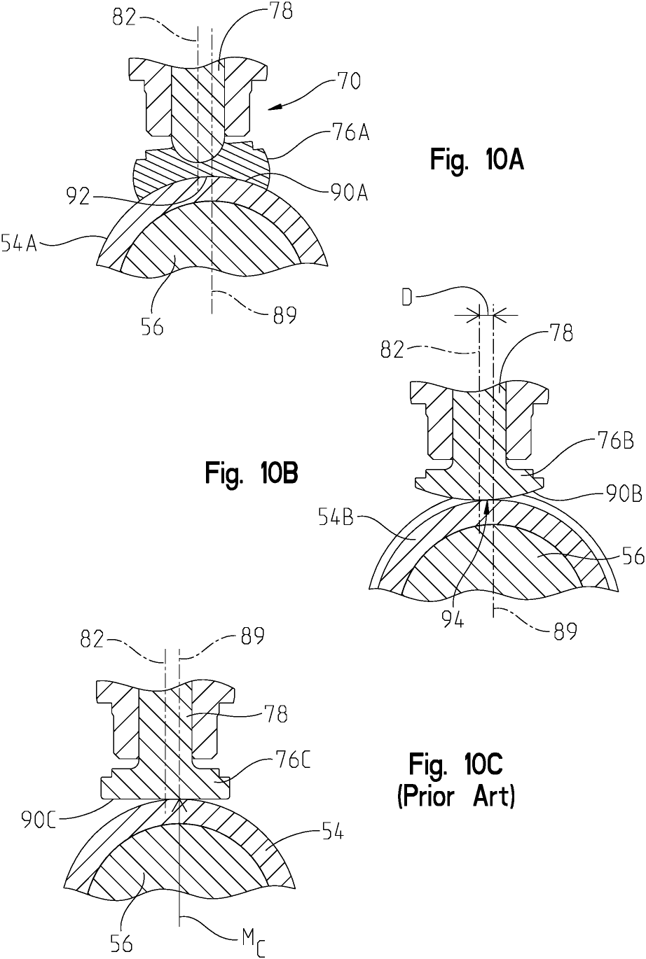

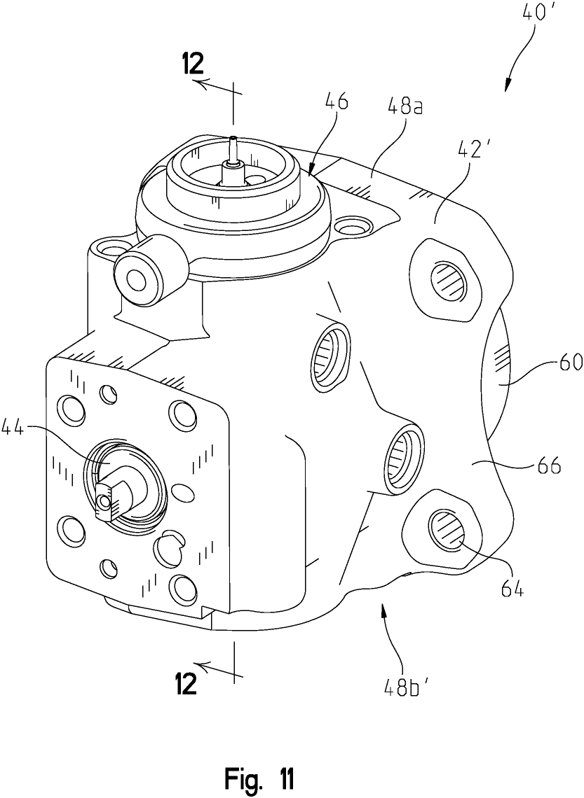

Conversely, as disclosed herein, cam roller 54 rotates or revolves about the outer surface of cam 56 and the reciprocating motion of plunger 70 allows the contact surface at the interface of plunger foot 76 and cam roller 54, as disclosed further in FIGS. 10A-10C, to be positioned on opposing sides of axis of rotation 50 and Y-axis 89, depending on the position of cam 56 during operation of pump 40. For example, as shown in FIG. 9, when cam 56 is positioned towards unit barrel pumping assembly 46a, plunger 70A is positioned adjacent valve assembly 72 and reciprocation axis 82 is positioned to the left side of Y-axis 89 and axis of rotation 50. However, when cam 56 is positioned towards unit barrel pumping assembly 46b, as shown in FIG. 7B, pumping chamber 74 of first unit barrel pumping assembly 46a has a maximum volume and reciprocation axis 82 may be at a different position relative to Y-axis 89 and axis of rotation 50 (e.g., reciprocation axis 82 may be aligned with or to the right of Y-axis 89 and axis of rotation 50). This movement of the contact surface of plunger foot 76 relative to axis 89 defines the rolling motion of plunger foot 76 during operation of fuel pump 40.

Referring now to FIGS. 10A-10C, plunger foot 76 may have varying configurations. For example, as shown in FIG. 10A, one embodiment of plunger foot 76 is shown as plunger foot 76A in which a contact surface 90A of plunger foot 76A, which is configured to contact a cam roller 54A, has a generally concave configuration. More particularly, contact surface 90A has a recessed portion 92 along a central portion of plunger foot 76A and generally at reciprocation axis 82 of plunger 70. As shown in FIG. 10B, one embodiment of plunger foot 76 is shown as plunger foot 76B in which a contact surface 90B of plunger foot 76B, which is configured to contact a cam roller 54B, has a generally convex configuration. More particularly, contact surface 90B has a protrusion 94 positioned generally at reciprocation axis 82 of plunger 70.

Additionally, cam roller 54 also may have varying configurations. For example, in some prior art embodiments, cam roller 54 may have a generally flat or linear configuration along the outer diameter thereof, as shown in FIG. 10C. In other embodiments, cam roller 54 may have an arcuate or curved outer surface extending in a direction generally parallel to the length of camshaft 44 (i.e., in the Z-direction). Illustratively, cam roller 54 may have a generally convex configuration along the outer diameter thereof, such that the outer surface of cam roller 54 is curved upwardly towards an apex along a laterally central portion of the outer surface, as shown as cam roller 54A of FIG. 10A. In yet further embodiments, cam roller 54 may have a generally concave configuration along the outer diameter thereof, such that the outer surface of cam roller 54 includes a groove or recessed portion defined along the laterally central portion of the outer surface, as shown as cam roller 54B in FIGS. 7A, 7B, and 10B.

Conversely, as shown in FIG. 10C, a prior art version of plunger foot 76 is shown as plunger foot 76C in which a contact surface 90C of plunger foot 76C, which is configured to contact cam roller 54, has a generally flat or linear configuration. As shown in FIGS. 10A-10C, when plunger foot 76 has a concave configuration (FIG. 10A) or convex configuration (FIG. 10B) and/or when cam roller 54 has a convex (FIG. 10A) or concave configuration (FIG. 10B), the resulting contact interface at contact surface 90 may be reduced, compared to the embodiment of FIG. 10C, in the direction of an X-axis extending perpendicularly to Y-axis 89. To offset this reduced contact interface, the geometry of either plunger foot 76 or cam roller 54 may be configured as shown in FIGS. 10A and 10B to increase the distribution of the load in the Z-direction (perpendicular to Y-axis 89 and the X-axis at least parallel to axes 85, 87).

During operation of fuel pump 40, there is a rolling motion between plunger foot 76 and cam roller 54 which is apparent from the relative location of the centerline of cam roller 54 (positioned along axis 89) compared to reciprocation axes 82, 88 of plunger 70A, 70B at various stages of the plunger stroke. For example, during one portion of the plunger stroke, a contact distance D may be defined on a first or right side of the cam roller centerline along axis 89 but may be defined on a second or left side of the cam roller centerline during a different portion of operation of pump 40. Additionally, during further portions of operation of pump 40, contact distance D may be defined as a single tangency when axis 82 of plunger 70A is colinear with axis 89. This is similar for plunger 70B when axis 88 is colinear with axis 89.

The configuration of contact surfaces 90A, 90B of FIGS. 10A, 10B and cam rollers 54A, 54B, respectively, may improve the fatigue capability of plunger 70 at plunger foot transitions, reduce plunger to barrel side loading forces, thereby reducing both wear and scuffing power losses, reduce sliding motion at the interface between plunger foot 76 to cam roller 54, and provide internal forces to limit motion of cam roller 54 in the Z-direction (perpendicular to Y-axis 89 and the X-axis at least parallel to axes 85, 87), thereby eliminating an additional thrust load carrying feature. Conversely, in the embodiment FIG. 10C, there is nothing to prevent cam roller 54 from shuttling side-to-side and retaining elements may be needed to prevent such side-to-side movement in the Y-Z plane.

In the embodiments of FIGS. 10A and 10B, due to the curved geometric configurations of plunger foot 76A, 76B and cam roller 54A and 54B, the load distribution at cam roller 54A, 54B and plunger foot 76A, 76B, respectively, is increased. By increasing the load distribution at contact surfaces 90A and 90B compared to the localized point load at contact surface 90C, bending stresses on plunger foot 76A, 76B are reduced compared to bending stresses on plunger foot 76C of FIG. 10C.

More particularly, when plunger 70C of FIG. 10C is at a half-stroke position (i.e., is halfway between top-dead-center (FIG. 7A) and bottom-dead-center (FIG. 7B)), the contact force which acts at contact surface 90C creates a moment of force in a direction which promotes clockwise rotation of plunger 70C. To counteract this relatively large moment, equally large forces at plunger 70C within unit barrel pumping assembly 46 act to promote a counteracting counterclockwise rotation of plunger 70C. In order to act to counteract the net X-axis directional force which acts on plunger 70C, the force which acts closest to pumping chamber 74 pushes plunger 70C to the left while the force which acts furthest from pumping chamber 74 acts to push plunger 70C to the right. These forces create a bending tensile stress on the right side of plunger foot 76C and a bending compression stress on the left side of plunger foot 76C.

Similarly, when plunger 70C is at the top-dead-center position (FIG. 7B), the directionality of the forces which act between plunger 70C and unit barrel pumping assembly 46 and the bending stresses are reversed, in that the force at contact surface 90C creates a moment of force Me (FIG. 10C) in a direction to promote counterclockwise rotation of plunger 70C. To counteract this relatively large moment Me, equally large forces at plunger 70C act to promote a counteracting clockwise rotation of plunger 70C. In order to counteract the net X-axis directional force which acts on plunger 70C, the force which acts closest to pumping chamber 74 now acts to push plunger 70C to the right while the force which acts furthest from pumping chamber 74 acts to push plunger 70C to the left. These forces create a bending compressive stress at the right side of plunger foot 76C and a bending tensile stress at the left side of plunger foot 76C.

Comparatively, and with respect to the embodiments of plunger foot 76A, 76B of FIGS. 10A and 10B, the curved geometry of plunger foot 76A, 76B and/or cam roller 54A, 54B act to reduce the magnitude of the force moment which is transmitted to plunger 70 by two mechanisms. First, the magnitude of the moment arm (e.g., MA (FIG. 9)) is reduced by a reduction of the force at contact surface 90A, 90B in the X-axis direction. Second, there is a change in the direction of the contact force at contact surface 90A, 90B which tends to act perpendicularly relative to the contact force at contact surface 90C (FIG. 10C). The directionality of the force at contact surface 90A, 90B act to produce a force moment which is in the opposing direction as that produced by the reduced moment arm directionality. As a result of the reduced force moment which acts on plunger 70 due to the contact force at contact surface 90A, 90B, there is a reduction in the guiding force magnitude between plunger 70 and unit barrel pumping assembly 46 which reduces efficiency losses, improves durability, and reduces the magnitude of the bending induces stresses at plunger foot 76A, 76B. Therefore, the embodiments of FIGS. 10A and 10B increase the pressure capability of fuel pump 40 and improve the durability thereof.

It may be appreciated that other surface features of plunger foot 76 and/or cam roller 54 may be used. For example, other than the spherical-radius configurations shown in FIGS. 10A and 10B, any simple or complex combination of straight or curved surfaces which act to distribute loading in the Z-direction between plunger foot 76 and cam roller 54 may be used. Additionally, plunger foot 76 and/or cam roller 54 may include features which affect the compliance and/or stiffness of contact surface 90 to affect the contact load distribution. Additionally, similar benefits may be achieved when plunger foot 76 is configured as plunger foot 76C (FIG. 10C) but is in contact with a convex cam roller, such as cam roller 54A of FIG. 10A or when cam roller 54 has a flat configuration as shown in FIG. 10C but is in contact with a convex plunger foot, such as plunger foot 76B of FIG. 10B.

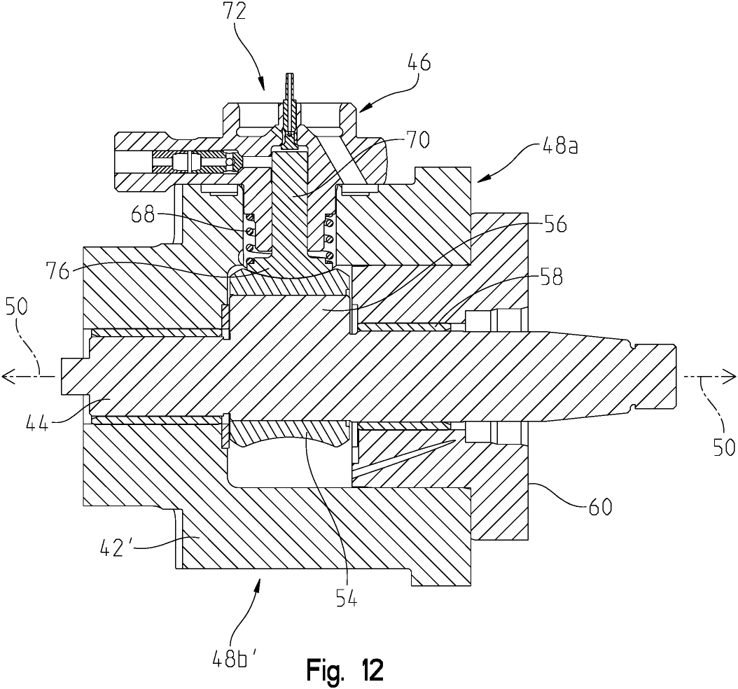

Referring to FIGS. 11 and 12, various embodiments of pump 40 may be shown as pump 40 and include a single unit barrel pumping assembly 46. As such, a housing 42′ of pump 40′ may include a closed second end 48b′ because second unit barrel pumping assembly 46b (FIG. 3) is not included.

It may be appreciated that any number of unit barrel pumping assemblies 46 may be removably coupled to housing 45 and, when a plurality of unit barrel pumping assemblies 46 are used, the distance between each unit barrel pumping assembly 46 is approximately equal. For example, if four unit barrel pumping assemblies 46 are included, each may be spaced approximately 90 degrees from each other about housing 42.

The present application expressly incorporates by reference herein the complete disclosures of International (PCT) Patent Application Serial No.PCT/US2019/062777, filed Nov. 22, 2019; International (PCT) Patent Application Serial No.PCT/US2020/021950, filed Mar. 11, 2020; U.S. Provisional Pat. Application Serial No. 63/065,741, filed Mar. 14, 2020; and U.S. Provisional Pat. Application Serial No. XX, filed XX, and entitled “FUEL PUMP DEVICES, SYSTEMS, AND METHODS” the Applicant of which is Cummins Inc.

While this invention has been described as having an exemplary design, the present invention may be further modified within the spirit and scope of this disclosure. For example, while the present disclosure refers to a fuel pump, the disclosure may be applicable to other components of a fluid system, such as an injector or doser. This application is therefore intended to cover any variations, uses, or adaptations of the invention using its general principles. Further, this application is intended to cover such departures from the present disclosure as come within known or customary practice in the art to which this invention pertains.

What is claimed is:

1. A pumping assembly, including:
a housing;
a drive member configured to extend within the housing; and
at least one unit barrel pumping assembly removably coupled to the housing and including a pumping member configured to move in response to movement of the drive member.

2. The pumping assembly of claim 1, wherein the housing is configured to couple with an engine in a plurality of orientations.

3. The pumping assembly of claim 2, wherein the housing includes apertures configured to align with the engine in the plurality of orientations.

4. The pumping assembly of claim 1, wherein the at least one unit barrel pumping assembly includes a first unit barrel pumping assembly removably coupled to a first side of the housing and a second unit barrel pumping assembly removably coupled to a second side of the housing opposite the first side of the housing.

5. The pumping assembly of claim 4, wherein the first unit barrel pumping assembly includes a first pumping member configured as a first plunger and the second unit barrel pumping assembly includes a second pumping member configured as a second plunger, and a first reciprocation axis of the first plunger is offset from a second reciprocation axis of the second plunger.

6. The pumping assembly of claim 5, wherein the first plunger is configured to reciprocate along the first reciprocation axis independently of reciprocal movement of the second plunger along the second reciprocation axis during operation of the pumping assembly.

7. The pumping assembly of claim 6, wherein the first unit barrel pumping assembly includes a first tension member in contact with the first plunger and the second unit barrel pumping assembly includes a second tension member in contact with the second plunger, and the second tension member is separate from the first tension member.

8. A pumping assembly, including:
a housing;
a drive member configured to extend through a portion of the housing;
a roller supported by a portion of the drive member; and
at least one unit barrel pumping assembly supported by the housing and including a plunger having a plunger foot, and the plunger foot is configured to engage a portion of the roller, and the roller is configured with one of a convex or concave geometric configuration and the plunger foot is configured with one of a convex or concave geometric configuration.

9. The pumping assembly of claim 8, wherein the plunger foot is configured with a concave geometric configuration and the roller is configured with a convex geometric configuration.

10. The pumping assembly of claim 8, wherein the plunger foot is configured with a convex geometric configuration and the roller is configured with a concave geometric configuration.

11. The pumping assembly of claim 8, wherein the at least one unit barrel pumping assembly includes a tension member configured to bias the plunger towards the roller, and at a portion of the plunger extends through the tension member.

12. The pumping assembly of claim 8, wherein the at least one unit barrel pumping assembly is removably supported by the housing.

13. A pumping assembly, including:
a housing;
a drive member configured to extend through a portion of the housing;
a roller supported by a portion of the drive member;
a first unit barrel pumping assembly supported by the housing and including a first plunger configured to reciprocate along a first reciprocation axis, and the plunger comprises a plunger foot having a curved contact surface; and
a second unit barrel pumping assembly supported by the housing an including a second plunger configured to reciprocate along a second reciprocation axis, and the second reciprocation axis is offset from the first reciprocation axis.

14. The pumping assembly of claim 13, wherein at least one of the first and second unit barrel pumping assemblies is removably supported by the housing.

15. The pumping assembly of claim 13, wherein the second plunger comprises a plunger foot having a curved contact surface.

16. The pumping assembly of claim 13, wherein the roller includes an arcuate outer surface extending in a direction parallel to a length of the drive member.

17. The pumping assembly of claim 16, wherein the arcuate outer surface of the roller includes a concave configuration.

18. The pumping assembly of claim 16, wherein the arcuate outer surface of the roller includes a convex configuration.
